(19) United States
(12) Patent Application Publication
(10) Pub. No.: US 2008/0105484 A1
(43) Pub. Date: May 8, 2008

(54) ELECTRONIC REDUNDANT STEER BY WIRE VALVE

(75) Inventors: Shawn A. KENNY, Ames, IA (US); John T. NEIDERT, Cleveland, SC (US); Matthew S. SCHULTZ, Easley, SC (US); James D. KOCH, Easley, SC (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/556,316

(22) Filed: Nov. 3, 2006

(51) Int. Cl. B62D 5/08

(52) U.S. Cl. 180/403

(57) ABSTRACT

A steering system for a vehicle that uses primary and secondary steering actuation devices in combination with primary and secondary valve elements to provide fluid flow within a valve body. The primary and secondary valve elements are both electrically actuated by a control unit such that if the primary steering actuation device or valve element fails the secondary steering actuation device and valve element can supply pilot oil to the system.

### BACKGROUND OF THE INVENTION

This invention relates to a steering device for a vehicle. More specifically, this invention relates to a steer by wire valve system.

Steering systems for hydraulically driven vehicles involve complex systems that use valve elements to control the operation of a spool valve. These systems however do not provide electric control of the movement of the spool valve, nor are they integrated into a single valve package.

Steering by wire driving systems eliminate the mechanical link between the steering wheel and wheels by providing two separate closed control system loops. The first loop controls the actuation associated with the steering wheel while the second loop controls the actuation associated with the wheels. By combining the two with a control unit improved vehicle handling is achieved. Despite these advantages often times the steering actuators and valves used in the steer by wire system become worn and malfunction causing the entire system to be replaced.

Therefore, it is a principal object of the present invention to provide an improved steer by wire steering system, with electrically redundant actuation.

Another object of the present invention is to provide an improved steer by wire steering system in a single package.

Yet another object of the present invention is to provide a durable, long lasting steering system for a vehicle.

These and other objects, features or advantages of the present invention will become apparent from the specification and claims.

### BRIEF SUMMARY OF THE INVENTION

The steering system for a vehicle. The steering system has a primary actuator that is fluidly connected to a primary valve element that is fluidly connected with a steer by wire valve body. Within the valve body is a proportional control spool valve that controls steering operations. Additionally the valve body empties or drains into a tank. The system also adds a secondary valve element that is fluidly connected to the valve body by a secondary valve element. Thus, when the primary valve element is in a first position and the secondary valve element is also in a first position, the primary valve directs pilot oil from the primary actuator to the proportional control spool valve while the secondary actuator directs fluid to the tank. When the primary actuator malfunctions a control unit is able to actuate the primary and secondary valve elements into second positions wherein the primary actuator directs fluid to the tank while the secondary actuator directs pilot oil to the proportional spool valve to continue operation of the steering system.

### BRIEF DESCRIPTION OF THE DRAWINGS

FIG. 1 is a schematic diagram of a steering system; and

FIG. 2 is a schematic diagram of a steering system.

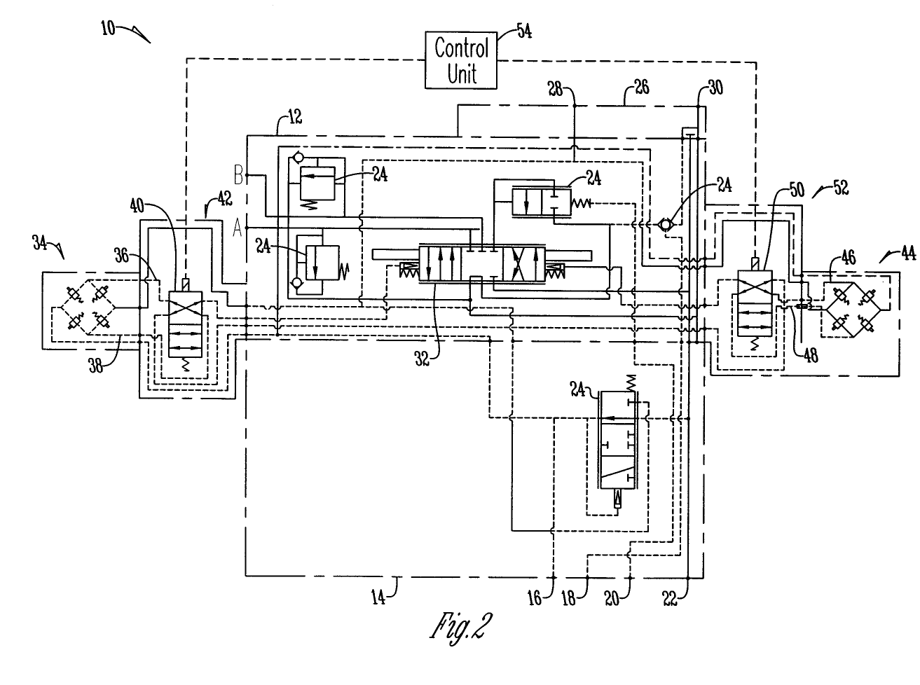

### DETAILED DESCRIPTION OF THE PREFERRED EMBODIMENT

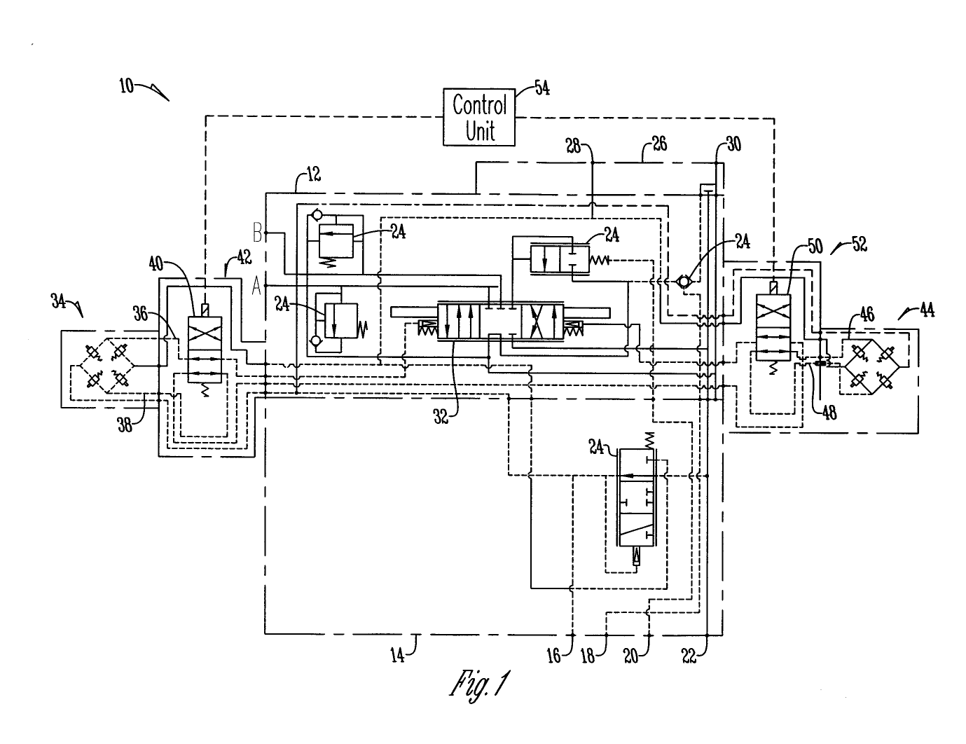

FIG. 1 shows a steering system 10 that is a steer by wire system used as a hydraulic steering system for a wheel loader or the like. The system contains a valve body 12 with an inlet 14 that has a pilot pressure port 16, a load sense port 18, a high system load sense pressure port 20, and a pressure port 22. In a preferred embodiment the valve body is a wire valve body. The inlet ports 16, 18, 20 and 22 allow fluid to flow within the system to a plurality of valve elements 24 within the valve body 12 to an outlet 26 that contains a low pressure tank port 28 and a tank port 30. Additionally, within the valve body 12 is a proportional control spool valve 32.

Fluidly connected to the valve body 12 is a primary steering actuator 34 that fluidly connects with the valve body 12 via first and second primary fluid lines 36 and 38 that flow through primary valve element 40 to the valve body 12. The primary valve element 40 is within a primary cartridge manifold 42 and in a preferred embodiment is a solenoid cartridge control valve.

The primary valve element 40 in a first position provides a direct fluid flow path for directing pilot oil from the primary steering actuator 34 to the proportional control spool valve 32 to actuate this valve. Meanwhile, when the primary valve element 40 is actuated the valve creates a fluid flow path that directs pilot oil from the primary steering actuator 34 to drain out of the low pressure tank 28.

On the opposite side of the valve body 12 a secondary steering actuator 44 provides first and second secondary fluid lines 46, 48 that flow into a secondary valve element 50 within a secondary cartridge manifold 52. In a preferred embodiment the secondary valve element 50 is a solenoid cartridge control valve. The secondary valve element 50 operates such that when in a first position a fluid flow path directs pilot oil from the secondary steering actuator 44 to drain from the low pressure tank. Whereas when actuated in a second position the control valve 50 provides a fluid flow path that directs pilot oil from the second steering actuator 44 to the proportional control spool valve 32 to actuate the valve.

In a preferred embodiment the primary and secondary valve elements 40 and 50 are electrically controlled by a control unit 54. The control unit 54 monitors the functioning of the primary actuator 34 and valve element 40 such that when a failure in either is detected the control unit 54 simultaneously actuates the primary and secondary valve elements 40 and 50 from their first positions to their second positions.

Thus, in operation when the primary valve element 40 and secondary valve element 50 are in a first position, pilot oil flows from the primary steering actuator to the proportional control spool valve 32 to operate the system 10 while the secondary steering actuator 44 drains pilot oil to the low pressure tank 28 or tank 30. When a malfunction is detected within the primary valve element 40 the controller or control unit 54 sends a signal to actuate the primary valve element 40 from a first primary position wherein the pilot oil flows to the proportional control valve 32 from the primary actuator 34 to a second primary position wherein the pilot oil flows from the primary actuator 34 to the tank 28.

Simultaneously, the control unit 54 actuates the secondary valve element 50 from a first secondary position wherein pilot oil flows from secondary actuator 44 to the tank 28 to a second secondary position wherein the pilot oil flows from the secondary actuator 44 to the proportional control spool valve 32. Thus, the proportional control spool valve 32 remains operational despite malfunction of the primary valve element 40 or the primary steering actuator 34. Additionally this arrangement allows a controller to electrically control the operation of the spool valve 32 by positioning the primary and secondary valve elements 40 and 50.

Therefore, the valve or steering system 10 contains an integral secondary electronic valve actuator to allow proportional control of the spool in the event the primary electronic valve actuator fails. The secondary actuator can provide equal performance and functionality of the primary actuator. This design, by having a single package, also allows mobility for usage on the smaller product line of proportional hydraulic valve. Thus, at the very least, all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A steering system for a vehicle comprising:
a primary steering actuator;
a primary cartridge manifold having a primary valve element fluidly connected to the primary steering actuator;
a valve body having an inlet and an outlet to a tank and having a proportional control spool valve therein fluidly connected to the primary valve element;
wherein the primary valve element directs pilot oil from the primary steering actuator to the proportional control spool valve in a first primary position;
a secondary steering actuator fluidly connected to the valve body via a secondary valve element in a secondary cartridge manifold; and
wherein the secondary valve element fluidly connects the secondary steering actuator to the tank in a first position.

2. The steering system of claim 1 wherein the primary actuator directs pilot oil to the tank when the primary valve element is in a second primary position.

3. The steering system of claim 1 wherein the secondary actuator directs pilot oil to the proportional control spool valve when the secondary valve element is in a second position.

4. The steering system of claim 1 wherein the primary and secondary valve elements are solenoid cartridge control valves.

5. The steering system of claim 1 wherein the valve body is a wire valve body.

6. A method of supplying pilot oil to a proportional control spool valve, steps comprising:
providing primary and secondary actuators fluidly connected to a wire valve having a proportional control spool valve and a tank via primary and secondary valve elements;
actuating the primary valve element from a first primary position wherein pilot oil flows to the proportional control spool valve from the primary actuator to a second primary position wherein pilot oil flows from the primary actuator to the tank; and
actuating the secondary valve element from a first position wherein pilot oil flows from the secondary actuator to the tank to a second position wherein pilot oil flows from the secondary actuator to the proportional control spool valve.

7. The method of claim 6 wherein the primary and secondary valve elements are in a primary and secondary cartridge manifold.

8. The method of claim 6 wherein a control unit actuates the primary and secondary valves when a failure is detected in the primary actuator.

9. The method of claim 6 wherein a control unit actuates the primary and secondary valves when a failure is detected in the primary valve element.
